(19) United States
(12) Patent Application Publication
(10) Pub. No.: US 2015/0202653 A1
(43) Pub. Date: Jul. 23, 2015

(54) MAGNETIC PRINTING APPARATUS AND MAGNETIC PRINTING METHOD

(71) Applicant: HUIZHOU FORYOU OPTICAL TECHNOLOGY CO., LTD., Huizhou City, Guangdong Province (CN)

(72) Inventors: Yumin Liao, Huizhou City (CN); Xing Wang, Huizhou City (CN); Yifeng Yang, Huizhou City (CN)

(21) Appl. No.: 14/419,242

(22) PCT Filed: Jun. 25, 2013
(86) PCT No.: PCT/CN2013/077882

§ 371 Date: Feb. 2, 2015

(30) Foreign Application Priority Data
Aug. 3, 2012 (CN) 201210277677.0

(51) Int. Cl. B05D 3/00; B05C 19/00

(52) U.S. Cl. CPC B05D 3/207; B05C 19/00

(57) ABSTRACT

A magnetic printing apparatus and a magnetic printing method are disclosed. The magnetic printing apparatus comprises a printing device, a magnetically orientating device and a curing device. The printing device is adapted to form a magnetic-ink layer, wherein the magnetic-ink layer comprises a plurality of magnetic pigment flakes therein. The magnetically orientating device is adapted to magnetically orientate the magnetic pigment flakes. The curing device is adapted to cure the magnetic-ink layer. The magnetically orientating device comprises at least one cylindrical magnet that has an S-pole side surface, an N-pole side surface and an end surface for connecting the aforesaid two side surfaces. When being observed from the end surface, at least one of the aforesaid two side surfaces is a curved surface, and the printing substrate is disposed above or beneath the end surface to form an arc-shaped magnetically orientated pattern in the magnetic-ink layer.

### FIELD OF THE INVENTION

The present disclosure generally relates to the technical field of magnetic orientation printing, and more particularly, to a magnetic printing apparatus and a magnetic printing method.

### BACKGROUND OF THE INVENTION

Nowadays, magnetic photochromic pigment flakes have found wide application in various anti-fake fields. In addition to providing a photochromic effect of the traditional photochromic pigment, the magnetic photochromic pigment flakes can also be orientated along a magnetic field. Thus, during printing and curing processes, a human-made specific magnetic field needs to be formed within a magnetic-ink layer that comprises the magnetic photochromic pigment flakes therein so that the magnetic photochromic pigment flakes can be oriented at different angles in different areas. Thereby, the magnetic photochromic pigment flakes can produce special photochromic patterns in a printing.

However, in the prior art, the S-pole side surface and the N-pole side surface of a magnet used in the magnetically orientating process are generally in the form of parallel planes, so only strip-shaped magnetically orientated patterns can be formed within the magnetic-ink layer and the pattern effect is too simple, specifically as shown in FIG. 1.

### SUMMARY OF THE INVENTION

A primary technical problem to be solved by the present disclosure is to provide a magnetic printing apparatus and a magnetic printing method that enable the magnetic pigment flakes to produce special arc-shaped magnetically orientated patterns in a printed product.

To solve the aforesaid technical problem, one technical solution adopted by the present disclosure is to provide a magnetic printing apparatus which comprises a printing device, a magnetically orientating device, a curing device and a transferring device. The printing device is adapted to coat magnetic ink on a printing substrate to form a magnetic-ink layer, wherein the magnetic-ink layer comprises a plurality of magnetic pigment flakes therein. The magnetically orientating device is adapted to magnetically orientate the magnetic pigment flakes in the magnetic-ink layer. The curing device is adapted to cure the magnetic-ink layer. The transferring device is adapted to transfer the printing substrate through the printing device, the magnetically orientating device and the curing device. The magnetically orientating device comprises at least one cylindrical magnet that has an S-pole side surface, an N-pole side surface and an end surface for connecting the S-pole side surface and the N-pole side surface, and when being observed from the end surface, at least one of the S-pole side surface and the N-pole side surface comprises at least two planes connected with each other at a predetermined angle, and the printing substrate is disposed above or beneath the end surface to form an arc-shaped magnetically orientated pattern in the magnetic-ink layer.

Preferably, the predetermined angle is 90°.

Preferably, the cylindrical magnet is a regular quadrangular prism, two adjacent side surfaces of the regular quadrangular prism form the S-pole side surface, and the other two adjacent side surfaces form the N-pole side surface.

Preferably, the transferring device comprises a rolling drum, and the cylindrical magnet is disposed in the rolling drum and rotates synchronously with the rolling drum.

To solve the aforesaid technical problem, another technical solution adopted by the present disclosure is to provide a magnetic printing apparatus which comprises a printing device, a magnetically orientating device and a curing device. The printing device is adapted to coat magnetic ink on a printing substrate to form a magnetic-ink layer, wherein the magnetic-ink layer comprises a plurality of magnetic pigment flakes therein. The magnetically orientating device is adapted to magnetically orientate the magnetic pigment flakes in the magnetic-ink layer. The curing device is adapted to cure the magnetic-ink layer. The magnetically orientating device comprises at least one cylindrical magnet that has an S-pole side surface, an N-pole side surface and an end surface for connecting the S-pole side surface and the N-pole side surface, and when being observed from the end surface, at least one of the S-pole side surface and the N-pole side surface is a curved surface, and the printing substrate is disposed above or beneath the end surface to form an arc-shaped magnetically orientated pattern in the magnetic-ink layer.

Preferably, when being observed from the end surface, at least one of the S-pole side surface and the N-pole side surface is an arc-shaped curved surface.

Preferably, when being observed from the end surface, at least one of the S-pole side surface and the N-pole side surface comprises at least two planes connected with each other at a predetermined angle.

Preferably, the predetermined angle is 90°.

Preferably, the cylindrical magnet is a regular quadrangular prism, two adjacent side surfaces of the regular quadrangular prism form the S-pole side surface, and the other two adjacent side surfaces form the N-pole side surface.

Preferably, the magnetic printing apparatus further comprises a transferring device adapted to transfer the printing substrate through the printing device, the magnetically orientating device and the curing device.

Preferably, the transferring device comprises a rolling drum, and the cylindrical magnet is disposed in the rolling drum and rotates synchronously with the rolling drum.

To solve the aforesaid technical problem, one technical solution adopted by the present disclosure is to provide a magnetic printing method which comprises the following steps of: providing a printing substrate coated with a magnetic-ink layer, wherein the magnetic-ink layer comprises a plurality of magnetic pigment flakes therein; providing a cylindrical magnet, wherein the cylindrical magnet has an S-pole side surface, an N-pole side surface and an end surface for connecting the S-pole side surface and the N-pole side surface, and when being observed from the end surface, at least one of the S-pole side surface and the N-pole side surface is a curved surface; disposing the printing substrate above or beneath the end surface to form an arc-shaped magnetically orientated pattern in the magnetic-ink layer; and curing the magnetic-ink layer.

Preferably, when being observed from the end surface, at least one of the S-pole side surface and the N-pole side surface is an arc-shaped curved surface.

Preferably, when being observed from the end surface, at least one of the S-pole side surface and the N-pole side surface comprises at least two planes connected with each other at a predetermined angle.

Preferably, the cylindrical magnet is a regular quadrangular prism, two adjacent side surfaces of the regular quadrangular prism form the S-pole side surface, and the other two adjacent side surfaces form the N-pole side surface.

As compared to the prior art, the present disclosure has the following benefits: when being observed from the end surface, at least one of the S-pole side surface and the N-pole side surface of the cylindrical magnet used in the magnetic printing device and the magnetic printing method of the present disclosure is a curved surface, and the printing substrate is disposed above or beneath the end surface to form a special arc-shaped magnetically orientated pattern in the magnetic-ink layer so that the printed product presents various pattern effects.

### BRIEF DESCRIPTION OF THE DRAWINGS

FIG. 1 is a view illustrating the effect of a magnetically orientated pattern in a magnetic-ink layer in the prior art;

FIG. 2 is a schematic structural view of a magnetic printing apparatus according to a first embodiment of the present disclosure;

FIG. 3 is an end view of a magnetically orientating device according to the first embodiment of the present disclosure;

FIG. 4 is a view illustrating the effect of a magnetically orientated pattern in a magnetic-ink layer according to the first embodiment of the present disclosure;

FIG. 5 is an end view of a magnetically orientating device according to a second embodiment of the present disclosure;

FIG. 6 is an end view of a magnetically orientating device according to a third embodiment of the present disclosure;

FIG. 7 is a view illustrating the effect of a magnetically orientated pattern in a magnetic-ink layer according to a third embodiment of the present disclosure;

FIG. 8 is a schematic structural view of a magnetic printing apparatus according to a fourth embodiment of the present disclosure; and

FIG. 9 is a flowchart diagram of a magnetic printing method according to a fifth embodiment of the present disclosure.

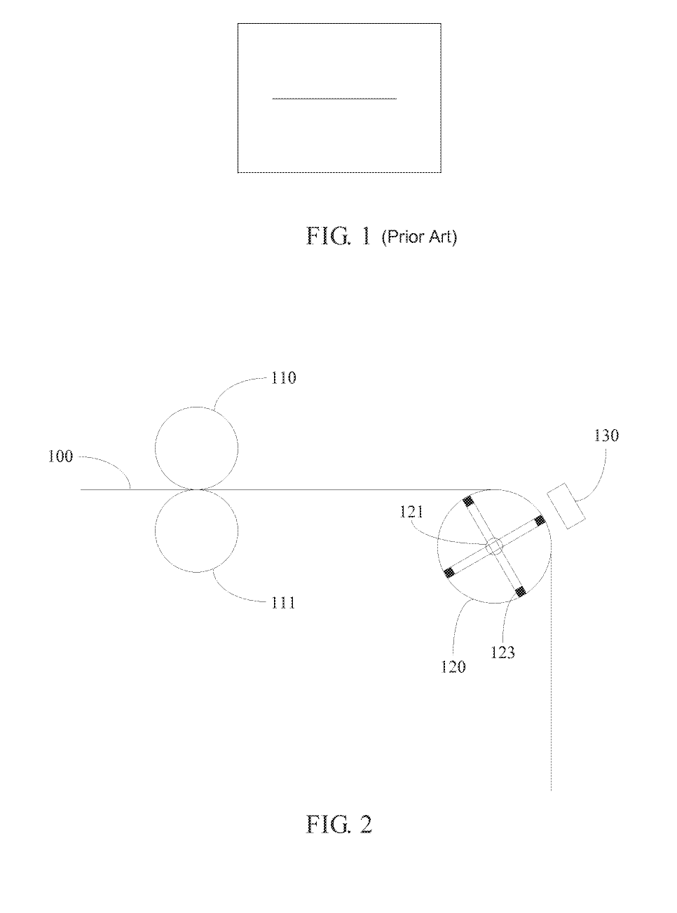

### DETAILED DESCRIPTION OF THE INVENTION

Referring to FIG. 2, FIG. 2 is a schematic structural view of a magnetic printing apparatus according to a first embodiment of the present disclosure. In this embodiment, the magnetic printing apparatus is a drum-type continuous printing apparatus and comprises printing devices 110, 111, a magnetically orientating device 123, a curing device 130 and a transferring device 120.

In this embodiment, the transferring device 120 transfers a printing substrate 100 through the printing devices 110, 111, the magnetically orientating device 123 and the curing device 130. The printing devices 110 and 111 are respectively cylinder-shaped so as to coat magnetic ink on the printing substrate 100, which is to be printed, in a drum printing manner to form a magnetic-ink layer (not shown). The printing substrate 100 may be a flexible material, e.g., a paper sheet, a paper board, a thin film or a plastic, that needs to be magnetically printed. The magnetic-ink layer comprises magnetic pigment flakes (not shown) therein that can be orientated along the magnetic field direction, e.g., magnetic photochromic pigment flakes.

In this embodiment, the transferring device 120 is a rolling drum, and the magnetically orientating device 123 is disposed within the rolling drum 120 and is driven by a driving device (not shown) to rotate about a rotating shaft 121 synchronously with the rolling drum 120. Thereby, when the printing substrate 100 is driven by the rolling drum 120 to move, the magnetic pigment flakes in the magnetic-ink layer coated on the surface of the printing substrate 100 are magnetically orientated by the magnetic field generated by the magnetically orientating device 123. Preferably, a plurality of magnetically orientating devices 123 are disposed within the rolling drum 120 along the circumference of the rolling drum 120.

The curing device 130 is disposed at the outer side of the rolling drum 120 and is adapted to cure the magnetic-ink layer after the magnetic pigment flakes in the magnetic-ink layer are magnetically orientated by the magnetically orientating devices 123. The curing device 123 may adopt various appropriate curing radiation sources, such as an ultraviolet (UV) light source, a thermal radiation source or any other device capable of curing the magnetic-ink layer onto the printing substrate 100.

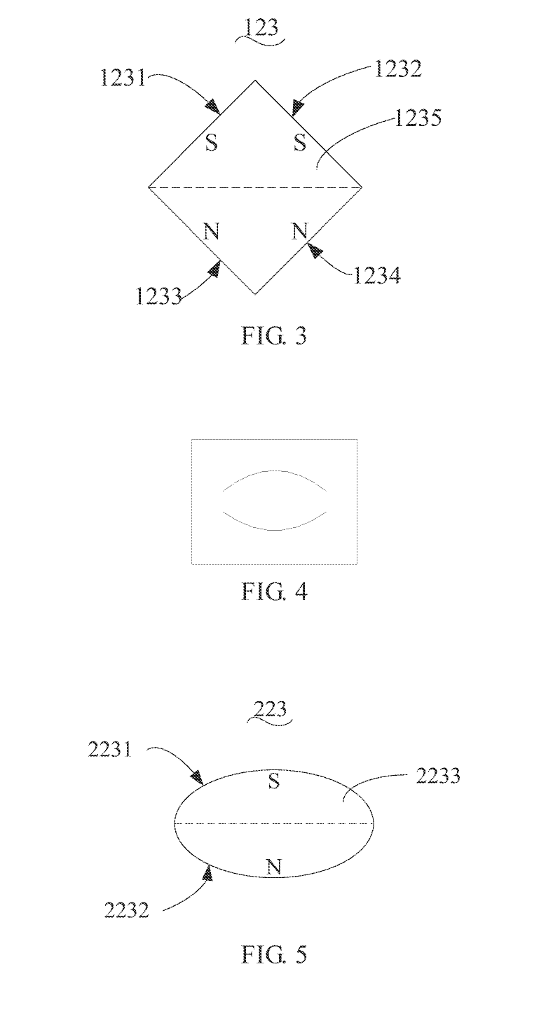

Referring to FIG. 3, there is shown an end view of a magnetically orientating device according to the first embodiment of the present disclosure. In this embodiment, the magnetically orientating device 123 is a cylindrical magnet shaped as a regular quadrangular prism and, specifically, comprises four side surfaces 1231, 1232, 1233, 1234 and an end surface 1235 for connecting the aforesaid side surfaces 1231, 1232, 1233, 1234. In this embodiment, when being observed from the end surface 1235, the cylindrical magnet 123 is square-shaped, with two adjacent side surfaces 1231, 1232 being the S-pole side surfaces and the other two adjacent side surfaces 1233, 1234 being the N-pole side surfaces. Thus, a distance between the S-pole side surfaces 1231, 1232 and the N-pole side surfaces 1233, 1234 decreases gradually from the center to the two sides along a diagonal line of the end surface 1235. When the printing substrate 100 is disposed above or beneath the end surface 1235, two symmetrical arc-shaped magnetically orientated patterns can be formed in a magnetic-ink layer 101, specifically as shown in FIG. 4. Further speaking, in other embodiments, at least one of the S-pole side surface and the N-pole side surface of the cylindrical magnet 123 may be designed to comprise at least two planes connected with each other at a predetermined angle (e.g.,) 90° so that the cylindrical magnet 123, when being observed from the end surface, is of some other shape, e.g., a rhombus, a rectangle, a trapezoid, etc.

Referring to FIG. 5, FIG. 5 is an end view of a magnetically orientating device according to a second embodiment of the present disclosure. In this embodiment, a magnetically orientating device 223 is a cylindrical magnet shaped as an elliptic cylinder. The cylindrical magnet 223, when being observed from an end surface 2233, is oval-shaped. The side surface of the cylindrical magnet 223 is divided into an S-pole side surface 2231 and an N-pole side surface 2232 along a major axis of the oval. When the printing substrate 100 is disposed above or beneath the end surface 2233, two symmetrical arc-shaped magnetically orientated patterns can also be formed in the magnetic-ink layer. In other embodiments, the S-pole side surface and the N-pole side surface may also be divided along a minor axis of the oval. Further, when being observed from the end surface, at least one of the S-pole side surface and the N-pole side surface of the cylindrical magnet 223 may be any other arc-shaped curved surfaces in other embodiments. In this embodiment, the effect of the magnetically orientated pattern of the magnetic-ink layer is similar to that of the previous embodiment.

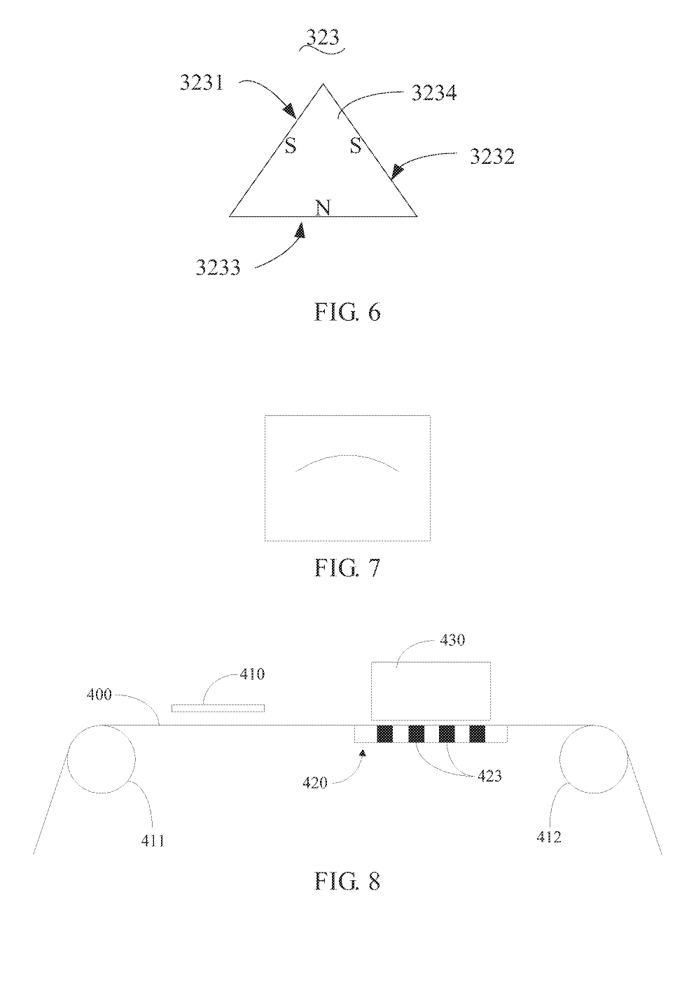

Referring to FIG. 6, there is shown an end view of a magnetically orientating device according to a third embodiment of the present disclosure. In this embodiment, the magnetically orientating device 323 is a cylindrical magnet shaped as a triangular prism. The cylindrical magnet 323, when being observed from an end surface 3234, is triangle-shaped, with two side surfaces 3231, 3232 being S-pole side surfaces 3231, 3232 and the other side surface 3233 being an N-pole side surface 3233. When the printing substrate 100 is disposed above or beneath the end surface 3234, an arc-shaped magnetically orientated pattern can be formed in the magnetic-ink layer, specifically as shown in FIG. 7.

According to the above descriptions, the magnetically orientating device of the magnetic printing apparatus according to the present disclosure comprises at least one cylindrical magnet that has an S-pole side surface, an N-pole side surface and an end surface for connecting the S-pole side surface and the N-pole side surface, and when being observed from the end surface, at least one of the S-pole side surface and the N-pole side surface is a curved surface so that the distance between the S-pole side surface and the N-pole side surface varies gradually towards the lateral direction of the cylindrical magnet. When the printing substrate is disposed above or beneath the end surface, an arc-shaped magnetically orientated pattern can be formed in the magnetic-ink layer.

Referring to FIG. 8, there is shown a schematic structural view of a magnetic printing apparatus according to a fourth embodiment of the present disclosure. In this embodiment, the magnetic printing apparatus is an intermittent printing device that comprises transferring devices 411, 412, a printing device 410, a magnetically orientating device 420 and a curing device 430.

The transferring devices 411, 412 are adapted to transfer a printing substrate 400 through the printing device 411, the magnetically orientating device 420 and the curing device 430 intermittently.

The printing device 411 is a planographic printing device (e.g., a screen printing device or a gravure printing device), and is adapted to coat a magnetic-ink layer on the printing substrate 400 in the transferring section between the transferring devices 411, 412.

The magnetically orientating device 420 preferably comprises a plurality of cylindrical magnets 423 arranged in a matrix form so as to magnetically orientate the magnetic pigment flakes comprised in the magnetic-ink layer of the printing substrate 400 in the transferring section between the transferring devices 411, 412.

The curing device 430 and the magnetically orientating device 420 are disposed opposite to each other at two sides of the printing substrate 400 respectively. In this embodiment, the curing device 430 is disposed above the magnetically orientating device 420. After the magnetic pigment flakes in the magnetic-ink layer are magnetically orientated by the magnetically orientating device 420, the magnetic-ink layer is cured by the curing device 430.

In this embodiment, the cylindrical magnet 423 may adopt any cylindrical magnet described in the aforesaid embodiments, and this will not be further described herein.

In the aforesaid embodiments, the cylindrical magnet is, for example, a permanent magnet, e.g., Al—Ni—Co, a ferrite, Rb—Fe—B, a Sm—Co alloy, a Fe—Cr—Co alloy, a Fe—Ni—Cu alloy, a Mn—Al—C alloy, a Pt—Co group alloy or a Pt—Fe group alloy. The three-dimensional shape of the cylindrical magnet may be in the form of a strip cylinder, a trapezoid platform, etc. The magnetic-ink layer may be cured through self-drying, e.g., infrared drying, thermal drying, air drying, etc. Moreover, the aforesaid magnetic printing apparatus is not limited to printing a full volume of paper or other printing substrates, but may also be used to print a single sheet of paper or other printing substrates.

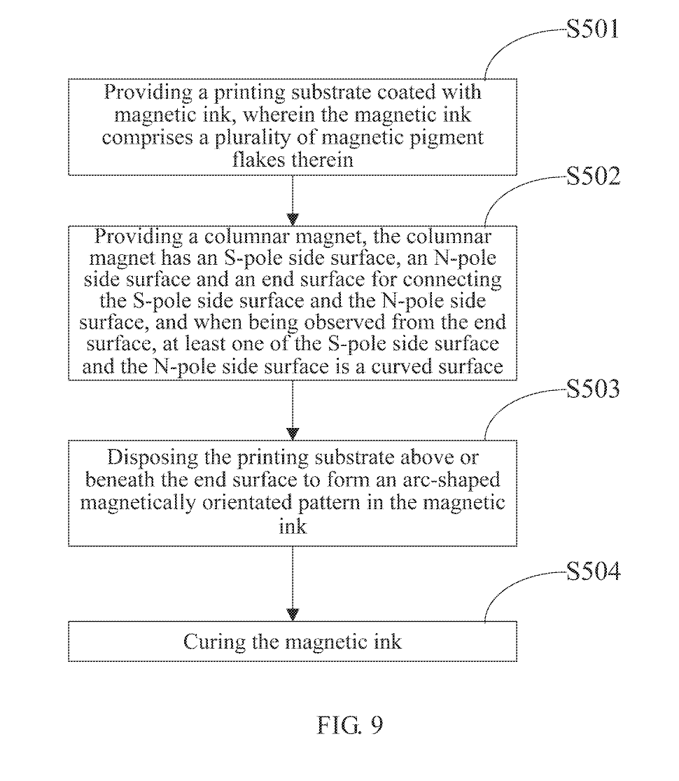

Referring to FIG. 9, FIG. 9 is a flowchart diagram of a magnetic printing method according to a fifth embodiment of the present disclosure. In this embodiment, the magnetic printing method comprises the following steps of:

in step S501, providing a printing substrate coated with a magnetic-ink layer, wherein the magnetic-ink layer comprises a plurality of magnetic pigment flakes therein;

in step S502, providing a cylindrical magnet. The cylindrical magnet has an S-pole side surface, an N-pole side surface and an end surface for connecting the S-pole side surface and the N-pole side surface, and when being observed from the end surface, at least one of the S-pole side surface and the N-pole side surface is a curved surface. In different embodiments, when being observed from the end surface, at least one of the S-pole side surface and the N-pole side surface is an arc-shaped curved surface or comprises at least two planes connected with each other at a predetermined angle. In a preferred embodiment, the cylindrical magnet is a regular quadrangular prism, two adjacent side surfaces of the regular quadrangular prism form the S-pole side surface, and the other two adjacent side surfaces form the N-pole side surface.

In step S503, disposing the printing substrate above or beneath the end surface to form an arc-shaped magnetically orientated pattern in the magnetic-ink layer; and

in step S504, curing the magnetic-ink layer.

In the aforesaid way, when being observed from the end surface, at least one of the S-pole side surface and the N-pole side surface of the cylindrical magnet used in the magnetic printing apparatus and the magnetic printing method of the present disclosure is a curved surface, and the printing substrate is disposed above or beneath the end surface to form a special arc-shaped magnetically orientated pattern in the magnetic-ink layer so that the printed product presents various pattern effects.

What described above are only the embodiments of the present disclosure, but are not intended to limit the scope of the present disclosure. Any equivalent structures or equivalent process flow modifications that are made according to the specification and the attached drawings of the present disclosure, or any direct or indirect applications of the present disclosure in other related technical fields shall all be covered within the scope of the present disclosure.

What is claimed is:

1. A magnetic printing apparatus, comprising:
a printing device, being adapted to coat magnetic ink on a printing substrate to form a magnetic-ink layer, wherein the magnetic-ink layer comprises a plurality of magnetic pigment flakes therein;
a magnetically orientating device, being adapted to magnetically orientate the magnetic pigment flakes in the magnetic-ink layer;
a curing device, being adapted to cure the magnetic-ink layer;
a transferring device, being adapted to transfer the printing substrate through the printing device, the magnetically orientating device and the curing device;
wherein the magnetically orientating device comprises at least one cylindrical magnet that has an S-pole side surface, an N-pole side surface and an end surface for connecting the S-pole side surface and the N-pole side surface, and when being observed from the end surface, at least one of the S-pole side surface and the N-pole side surface comprises at least two planes connected with each other at a predetermined angle, and the printing substrate is disposed above or beneath the end surface to form an arc-shaped magnetically orientated pattern in the magnetic-ink layer.

2. The magnetic printing apparatus of claim 1, wherein the predetermined angle is 90°.

3. The magnetic printing apparatus of claim 1, wherein the cylindrical magnet is a regular quadrangular prism, two adjacent side surfaces of the regular quadrangular prism form the S-pole side surface, and the other two adjacent side surfaces thereof form the N-pole side surface.

4. The magnetic printing apparatus of claim 1, wherein the transferring device comprises a rolling drum, and the cylindrical magnet is disposed in the rolling drum and rotates synchronously with the rolling drum.

5. A magnetic printing apparatus, comprising:
a printing device, being adapted to coat magnetic ink on a printing substrate to form a magnetic-ink layer, wherein the magnetic-ink layer comprises a plurality of magnetic pigment flakes therein;
a magnetically orientating device, being adapted to magnetically orientate the magnetic pigment flakes in the magnetic-ink layer;
a curing device, being adapted to cure the magnetic-ink layer;
wherein the magnetically orientating device comprises at least one cylindrical magnet that has an S-pole side surface, an N-pole side surface and an end surface for connecting the S-pole side surface and the N-pole side surface, and when being observed from the end surface, at least one of the S-pole side surface and the N-pole side surface is a curved surface, and the printing substrate is disposed above or beneath the end surface to form an arc-shaped magnetically orientated pattern in the magnetic-ink layer.

6. The magnetic printing apparatus of claim 5, wherein when being observed from the end surface, at least one of the S-pole side surface and the N-pole side surface is an arc-shaped curved surface.

7. The magnetic printing apparatus of claim 5, wherein when being observed from the end surface, at least one of the S-pole side surface and the N-pole side surface comprises at least two planes connected with each other at a predetermined angle.

8. The magnetic printing apparatus of claim 7, wherein the predetermined angle is 90°.

9. The magnetic printing apparatus of claim 5, wherein the cylindrical magnet is a regular quadrangular prism, two adjacent side surfaces of the regular quadrangular prism form the S-pole side surface, and the other two adjacent side surfaces form the N-pole side surface.

10. The magnetic printing apparatus of claim 5, further comprising a transferring device adapted to transfer the printing substrate through the printing device, the magnetically orientating device and the curing device.

11. The magnetic printing apparatus of claim 10, wherein the transferring device comprises a rolling drum, and the cylindrical magnet is disposed in the rolling drum and rotates synchronously with the rolling drum.

12. A magnetic printing method, comprising the following steps of:
providing a printing substrate coated with a magnetic-ink layer, wherein the magnetic-ink layer comprises a plurality of magnetic pigment flakes therein;
providing a cylindrical magnet, wherein the cylindrical magnet has an S-pole side surface, an N-pole side surface and an end surface for connecting the S-pole side surface and the N-pole side surface, and when being observed from the end surface, at least one of the S-pole side surface and the N-pole side surface is a curved surface;
disposing the printing substrate above or beneath the end surface to form an arc-shaped magnetically orientated pattern in the magnetic-ink layer; and
curing the magnetic-ink layer.

13. The magnetic printing method of claim 12, wherein when being observed from the end surface, at least one of the S-pole side surface and the N-pole side surface is an arc-shaped curved surface or comprises at least two planes connected with each other at a predetermined angle.

14. The magnetic printing apparatus of claim 12, wherein the cylindrical magnet is a regular quadrangular prism, two adjacent side surfaces of the regular quadrangular prism form the S-pole side surface, and the other two adjacent side surfaces form the N-pole side surface.
